(19) United States
(12) Patent Application Publication
(10) Pub. No.: US 2006/0150454 A1
(43) Pub. Date: Jul. 13, 2006

(54) Magnetic multilayer pushpin board

(75) Inventor: Seesong Kang, Northbrook, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Northbrook, IL (US)

(21) Appl. No.: 11/290,930

(22) Filed: Nov. 30, 2005

Related U.S. Application Data
(60) Provisional application No. 60/638,567, filed on Dec. 22, 2004.

(51) Int. Cl. G09F 7/04

(52) U.S. Cl. 40/621

(57) ABSTRACT

Provided is a multilayer pushpin board for retaining and displaying messages that is capable of accommodating both pushpins and magnets. The multilayer message board includes a support substrate preferably made from an elastically recoverable elastomeric material that can be pierced by and releasably retain the spike of a pushpin. A composite sheet made from magnetic attractable particles dispersed into a binder material is secured to the support substrate. The composite sheet is thin and soft enough to allow the spike of a pushpin to penetrate therethrough. Preferably, a cover sheet is laid over and secured to the composite sheet, the cover sheet preferably being made of elastically recoverable elastomeric material. The cover sheet is thin enough to avoid interfering with the magnetic attraction associated with the composite sheet.

### FIELD OF THE INVENTION

This invention pertains generally to message boards and more particularly to a message board for receiving and retaining both pushpins and magnetic items.

### BACKGROUND OF THE INVENTION

Message boards for posting paper messages or other notations on are well known in the art. The various types of message boards can be suspended on a wall or other surface, or can be sized and configured for portability. Early message boards were made from cork or a similar deformable material that could be pierced by and retain a sharp pin or tack. Later, various natural and synthetic foams and rubbers were utilized to make message boards. One advantage of using foams and rubbers is the elastic characteristic demonstrated in many of these materials. Elasticity enables the message board to substantially recover the pierce hole created by the pin or tack. Accordingly, elastic message boards have a substantially longer useful life than cork boards, which typically deteriorate over time and use.

It is also known to use magnets and magnetic materials to post paper messages and notes. Magnetic message boards typically require a substrate of metallic material to magnetically attract a magnet. Paper or other thin items can be retentively held between the metallic substrate and magnet.

It is desirable to combine the features of pushpin and magnetic message boards in a multifunctional board that can accommodate both pins and magnets. Such a multifunctional board must demonstrate magnetic attraction without causing damage or excessive wear to the pushpins or tacks. It is also desirable that the multifunctional message board is durable and retains an aesthetically pleasing appearance. Likewise, it is desirable that the multifunctional board can be configured for suspension against a wall or for portable use.

### BRIEF SUMMARY OF THE INVENTION

The invention provides a multilayer pushpin board that can accommodate both pushpins and magnets. The multilayer pushpin board comprises a semi-rigid support substrate preferably made from an elastically recoverable elastomeric material. The elastomeric material can be displaced by and compressively hold the spike of a pushpin. Additionally, the semi-rigidity of the support substrate enables the multilayer pushpin board to be self-supporting and to retain its shape. To provide magnetic attraction for retaining magnets, at least a portion of the pushpin board is multilayered, and includes a piercible composite sheet laid over the support substrate. The composite sheet is made from magnetic attractable particles dispersed in a binder material. To hide the composite sheet and holes formed therein by pushpins, a cover sheet of elastically recoverable elastomeric material is laid over the composite sheet. The cover sheet can be made from the same elastomeric material as the support substrate or a different material. In various embodiments, to make written markings upon the multilayer pushpin board, a dry-erase surface can also be provided.

An advantage of the invention is that it provides a multilayer pushpin board that can accommodate both pushpins and magnets. The support substrate preferably provides sufficient support and rigidity that the board retains its shape without the need for a frame or backing, yet provides some flexibility, although a frame and/or backing may be provided. In larger boards, a dry write surface, backing or frame may provide additional support to the board. An additional advantage is that the multilayer pushpin board is both durable and retains an aesthetically pleasing appearance. These and other advantages of the invention, as well as additional inventive features, will be apparent from the description of the invention provided herein.

### BRIEF DESCRIPTION OF THE DRAWINGS

FIG. 1 is a perspective view of a multilayer pushpin board constructed in accordance with the teachings of the invention which can accommodate pushpins and magnets.

FIG. 2 is a fragmentary, cross sectional view taken through the multilayer pushpin board of FIG. 1 along line 2-2 which shows the support substrate, the composite sheet, and the cover sheet.

FIG. 3 is a perspective view of another embodiment of the multilayer pushpin board which includes a dry-erase surface and which is sized and shaped for portable handling.

FIG. 4 is a fragmentary, cross-sectional view taken through the multilayer pushpin board of FIG. 3 along line 4-4.

FIG. 5 is a perspective view of another embodiment of the multilayer pushpin board which includes a dry-erase surface and which is configured to be suspended from a wall partition.

### DETAILED DESCRIPTION OF THE INVENTION

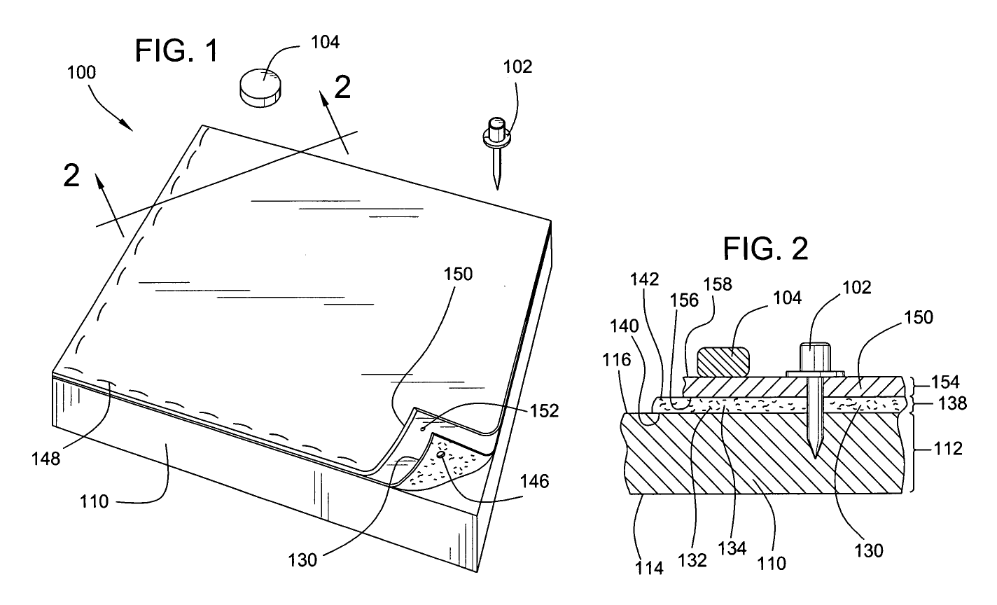

Now referring to the drawings, wherein like reference numbers refer to like features, there is illustrated in FIG. 1 a multilayer pushpin board 100 designed to accommodate both pushpins 102 and magnets 104. The multilayer pushpin board 100 can be provided in a multitude of shapes and sizes, and can be configured for portable handling or for suspension on a wall or similar surface. The multilayer pushpin board 100 includes a bottom support substrate 110, an intermediate composite sheet 130, and a top cover sheet 150.

The support substrate 110 may be made of any suitable substance, such as styrofoam, cardboard, cork, or polymeric material, but is preferably made from a recoverable elastomeric material. For example, a suitable elastomeric material is foamed ethyl vinyl acetate (EVA). To releasably retain a pushpin, the elastomeric material is capable of being pierced by and displaced around the spike of the pushpin 102. When the pushpin 102 is removed from the support substrate 110, the elastomeric material substantially recovers to substantially eliminate or mask the void created by the pushpin. By substantially recovering the voids, the elastomeric material presents an aesthetically pleasing appearance, as opposed to the pockmarked appearance typically presented by well-used pushpin boards of other materials. Additionally, because of the elastically recoverable characteristic of the elastomeric material, the support substrate is substantially more durable than materials such as cork or styrofoam. Furthermore, foamed EVA support substrate 110 typically yields the multilayer pushpin board 100 that is light-weight and easy to handle.

To provide semi-rigidity to the multilayer pushpin board 100, the support substrate 110 has a sufficient thickness 112 as defined between a first surface 114 and a spaced-apart second surface 116. For example, the thickness 112 is preferably about 6-10 millimeters or more. A semi-rigid support substrate 110 enables the multilayer pushpin board 100 to maintain its shape without the assistance of a frame or other support, although such a frame or other support may be provided without departing from the spirit and scope of the invention. In addition to providing a semi-rigid quality to the multilayer pushpin board 100, the thickness of the support substrate 110 is sufficient to accommodate the length of a pushpin spike, thereby preventing the spike from dangerously protruding beyond the first surface 114.

To make the multilayer pushpin board 100 magnetically attractive, a composite sheet 150 is laid over at least a portion of the support substrate 110. To enable a pushpin 102 to be releasably retained to the multilayer pushpin board 100, the composite sheet 130 is sufficiently soft and piercible to allow the spike of a pushpin to pierce through the composite sheet and into the support substrate 110. The composite sheet 130 is preferably made from a composite of magnetic attractable particles (sometimes referred to as magnetic or magnetizable particles) 132 dispersed into an elastomeric binder material 134. For the purposes of this disclosure and that attached claims, the term “magnetic attractable” will be used to refer to both magnetic and magnetizable particles. The magnetic attractable particles 132 can be dispersed into the binder material 134 before the binder material is caused to set. The magnetic attractable particles 134 can be any appropriate material, such as, for example, steel granules or flakes. Similarly, the elastomeric binder material 134 can be made of any appropriate material, such as, for example, chlorinated polyethylene.

Because of the dominate quantity of the elastomeric binder material 134, the composite sheet 130 demonstrates a rubber-like quality and is sufficiently piercible to allow the spike of the pushpin to pierce therethrough. Additionally, the piercible composite sheet 130 will not significantly dull or damage the spike of the pushpin over time. It will be appreciated by those of skill in the art that the thin composite sheet 150 is preferably sufficiently flexible enough to allow the composite sheet 150, as well as the multilayer push pin board 100 to be slightly flexible.

Composite sheets of this type are disclosed in documents such as U.S. Pat. No. 6,610,415 to Koslow. Suitable composite sheets 130 are available from various manufacturers under trade names such as Rubber Iron Sheet, and are sometimes referred to as “rubber steel”. An example of a composition of such a sheet is as follows, although the composition may vary, so long as the composite sheet 130 may attract and hold magnets in the particular pushpin board 100 and so long as it is penetrable by a pushpin spike. It will be appreciated that the composite sheet becomes increasingly attractive to magnets as the size and/or volume of metallic particles contained therein increases.

Magnetic Attractable Particles: DNC-240/DNC-255 T Fe 98.5%
C—0.02%
Sr—0.07%
Mn—0.40%
P—0.02%
Co—0.05%
Hci-insal—0.30%

Elastomeric Binder Material: Chlorinated Polyethylene (CPE)—90.0%
Fillers—8.0%
Other (water, softeners)—1.0%

The composite sheet 130 can be made with any appropriate thickness 138 defined between a third surface 140 and a fourth surface 142. In a current embodiment, the thickness 138 is on the order of about 0.5 millimeters, although alternate thicknesses may be utilized so long as the composite sheet 130 does not substantially resist the piercing force from a pushpin.

Additionally, the relatively thin composite sheet 130 demonstrates relative flexibility which simplifies manufacturing of the multilayer pushpin board 100. Because the support substrate 110 demonstrates a semi-rigid quality, however, the multilayer pushpin board 100 is overall semi-rigid and self-supporting.

To secure the composite sheet 130 to the support substrate 110, an adhesive can be applied between the second surface 116 of the support substrate and the third surface 140 of the composite sheet. However, in other embodiments, other securing methods can be employed. For example, the composite sheet 130 may be sewn to the support substrate 110 with stitches 148, although other methods such as heat welding or sonic welding are envisioned.

A typical problem with magnetic composite sheets is that they do not demonstrate sufficient elasticity or recoverability. This is in part due to the presence of the magnetic attractable particles which prevent the binder materials from moving. Hence, after a pushpin has been pierced into and removed from the multilayer pushpin board 100, a visible hole 146 typically remains in the composite sheet 130. To hide the holes 146 formed into the composite sheet 130, a cover sheet 150 is preferably disposed over the composite sheet. In this arrangement, the composite sheet 130 is sandwiched between the support substrate 110 and the cover sheet 150. Any pushpins 102 pierced into the multilayer pushpin board 100 must also penetrate through the cover sheet 150.

The cover sheet 150 may be of any appropriate material, such as a fabric, paper, piercable polymeric material or other material. It is preferred, however, that any mark left in the cover sheet 150 by the pushpin upon removal be minimized, masked, or eliminated upon removal. A layer of fabric or recoverable elastomeric material is particularly useful in this regard. Alternately, the cover sheet 150 may be formed of a fabric, piercable polymeric sheet, paper, or other material, although, preferably, the cover sheet 150 generally eliminates, minimizes, or masks the opening from where the tack has been removed. Because of the recoverable characteristics of the elastomeric material, the hole 152 formed into the cover sheet 150 by the pushpin 102 may be substantially eliminated, minimized, or masked upon removal.

Preferably, the cover sheet 150 is made from the same foamed EVA material as the support substrate though, in other embodiments, different materials can be used, as explained above. Referring to FIG. 2, the cover sheet 150 can be made with a thickness 154 defined between a fifth surface 156 and a sixth surface 158 of any appropriate thickness such that the cover sheet 150 is thin enough that it does not substantially obstruct magnet attraction between the composite sheet 130 and a magnet placed upon the cover sheet. The cover sheet is also preferably thick enough, resilient enough or of such an appearance that is it aesthetically appealing, particularly during use. In a current embodiment, the cover sheet 150 of foamed EVA has a thickness on the order of 1 millimeter, although alternate thicknesses, including thicknesses of up to and exceeding 2.5 mm, are envisioned. Depending upon the composition of the composite sheet 130, it is envisioned that composite sheets 130 having a thickness up to and beyond 2.0 mm may be appropriate, for example. It will be appreciated, that by including a composite sheet 130 that exhibits a greater attraction to magnets, as by including more and/or larger metallic particles, the multilayer pushpin board 100 may include a thicker or more obstructive cover sheet 150 yet still allow the effective use of magnets. Because of the small thickness of the cover sheet 150, even when made from foamed EVA, it demonstrates substantial flexibility compared to the semi-rigid support substrate 110.

To secure the cover sheet 150 to the rest of the multilayer pushpin board 100, adhesive can be placed between the fifth surface of the cover sheet 156 and the fourth surface 142 of the composite sheet 130. Alternatively, the cover sheet 150 and composite sheet 130 can be attached by any appropriate method depending upon the materials utilized, including, for example, such methods as heat or sonic welding, or sewing of the cover sheet 150 to the support substrate 110 with stitches 148.

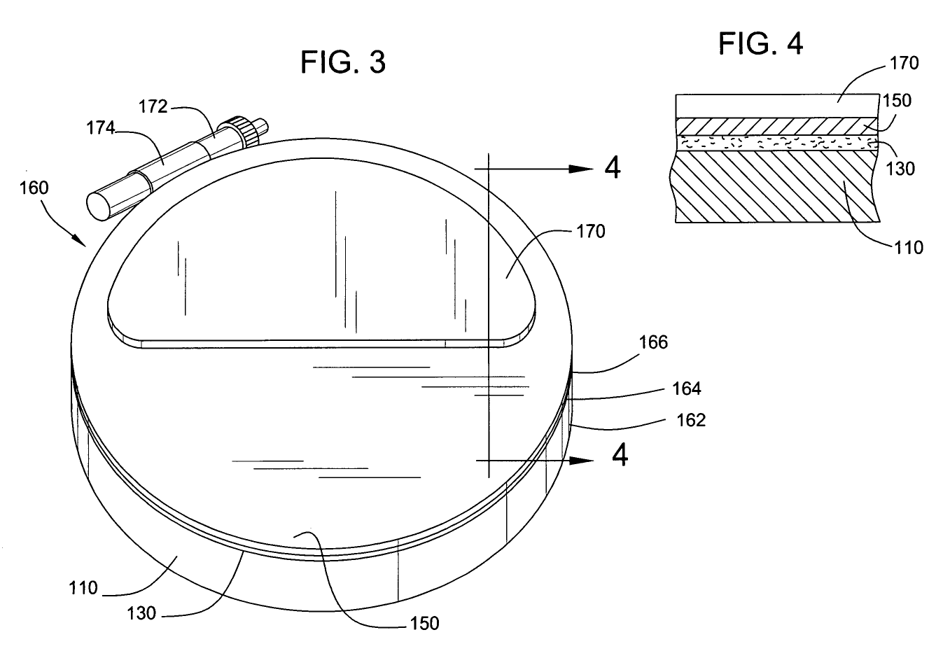

As mentioned above, the multilayer pushpin board can be provided in a variety of shapes and sizes. For example, in the embodiment illustrated in FIG. 3, the multilayer pushpin board can be provided as a portable, circular-shaped board 160. To form the circular shape, the multilayer pushpin board 160 can be die cut or stamped from a larger multilayer blank such as the multilayer board 100 illustrated in FIG. 1 and therefore includes the same three layers 110, 130, 150. Accordingly, the support substrate 110, the composite sheet 130, and the cover sheet 150 respectively define a first peripheral edge 162, a second peripheral edge 164, and a third peripheral edge 166, all having a corresponding shape and dimensions. It will be apparent to those of skill in the art that multilayer pushpin board can be formed in shapes other circular. It should also be appreciated that, by utilizing select fillers and dies, the elastomeric material comprising the support substrate 110 and cover sheet 130, as well as the composition sheet 150, can be provided in a variety of colors, densities, and flexibilities.

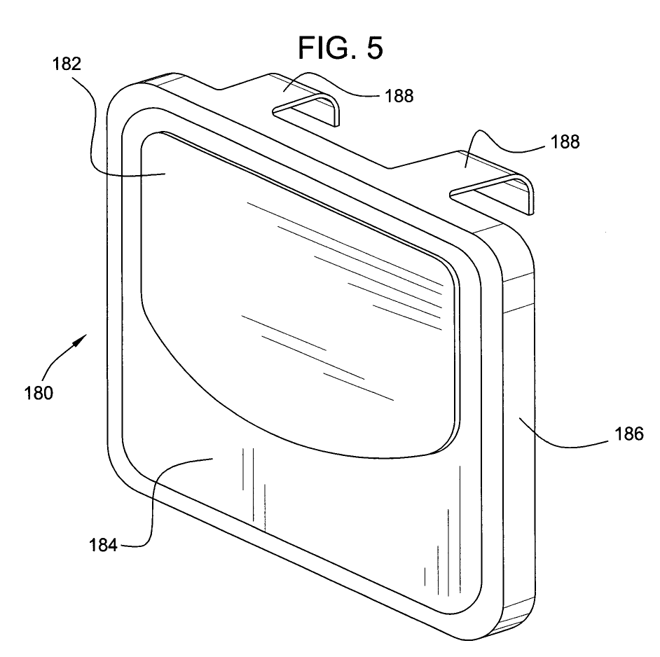

In a further embodiment, the multilayer pushpin board 160 can be provided with an exposed dry-erase surface 170 for making written markings on. The dry-erase surface 170, with or without surface coating, can be made from any suitable material developed in the art or presently known, including, for example, styrene. The dry-erase surface 170 can be provided over a first portion of the cover sheet 150 while leaving a second portion exposed for accommodating pushpins and magnets. Referring to FIG. 4, the dry-erase surface can be adhered directly onto the cover sheet 150. Other embodiments, however, are within the scope of the invention, By way of example only, the structure forming the dry-erase surface 170 can be disposed into the various layers of the multilayer pushpin board 160 itself. Alternately, the dry erase surface 170 may be placed on a portion of the support substrate 110, and the composite sheet 130 placed on another portion of the substrate 110. Other arrangements are likewise within the scope of the invention. Referring back to FIG. 3, to releasably retain a dry-erase marker 172 to the multilayer pushpin board 160, a plastic C-clip 174 can be attached to the peripheral edges 162, 164, 166 of the board with, for example, adhesive.

While illustrated without a frame or a backing, it will be appreciated by those of skill in the art that either or both of a frame and backing may be provided. Referring to FIG. 5, there is illustrated another embodiment of the multilayer pushpin board 180 configured to be suspended from wall partitions or similar vertical surfaces that are often assembled together to form office spaces. The multilayer pushpin board 180 includes a dry-erase surface 182 laid over a cover sheet 184 that is otherwise exposed to accommodate pushpins and magnets. Extending about the peripheral edge of the multilayer pushpin board 180 is a plastic frame 186. Although the layers are preferably glued or otherwise secured together along their adjacent surfaces, it will be appreciated that the frame 184 can secure the edges of the various layers of the multilayer pushpin board 180 together and protects the layers from being peeled apart. The frame 184 may be mounted or hung by any appropriate means, if so desired. For example, formed along a top edge of the frame 184 of the multilayer pushpin board 180 in FIG. 5 are two hangers 188 that extend in the opposite direction as the dry-erase surface 182 and cover sheet 184. The hangers 188 can extend over and rest upon a top ledge of a wall partition to suspend the multilayer pushpin board 180. The board 180 may be relatively permanently disposed within the frame 184, or it may be removable to allow transport of the board itself.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multilayer pushpin board adapted to temporarily retain at least one magnet and to receive at least one pushpin spike having a length, said board comprising:
a support substrate, said support substrate comprising a surface; and
a piercable composite sheet comprising a magnetic attractable material dispersed into a binder material, the composite sheet overlaid on at least a portion of the surface of the support substrate, whereby said composite sheet is adapted to be pierced by said pushpin spike, said pushpin spike being received in said support substrate, and whereby the composite sheet is adapted to temporarily retain the magnet.

2. The multilayer pushpin board of claim 1 wherein the support substrate comprises a recoverable elastomeric material.

3. The multilayer pushpin board of claim 2, wherein the recoverable elastomeric material comprises foamed ethyl vinyl acetate.

4. The multilayer pushpin board of claim 1 further comprising a cover sheet overlaid on at least a portion of the composite sheet.

5. The multilayer pushpin board of claim 4, wherein the cover sheet is flexible.

6. The multilayer pushpin board of claim 4, wherein the cover sheet comprises at least one of the following: a recoverable elastomeric material, a fabric, or a paper.

7. The multilayer pushpin board of claim 6, wherein the support substrate and the cover sheet are comprised of the same recoverable elastomeric material.

8. The multilayer pushpin board of claim 4, wherein the cover sheet has a thickness of about 2.5 millimeters or less.

9. The multilayer pushpin board of claim 8, wherein the cover sheet has a thickness of about 1 millimeter or less.

10. The multilayer pushpin board of claim 4, wherein at least two of the composite sheet, the cover sheet, and the support substrate define respective peripherial edges of corresponding shape.

11. The multilayer pushpin board of claim 1, wherein the magnetic attractable material comprises ferrometallic particles and the binder material comprises a polymeric material.

12. The multilayer pushpin board of claim 1 wherein the binder material comprises at least one of chlorinated polyethylene or polyvinyl chloride.

13. The multilayer pushpin board of claim 1, wherein the composite sheet has a thickness of about 2.0 millimeters or less.

14. The multilayer pushpin board of claim 13, wherein the composite sheet has a thickness of about 0.5 millimeters or less.

15. The multilayer pushpin board of claim 1, wherein the composite sheet is flexible.

16. The multilayer pushpin board of claim 1, further comprising a dry-erase surface.

17. The multilayer pushpin board of claim 16, wherein the dry-erase surface is disposed along at least a portion of at least one of said surface of the support substrate and said composite.

18. The multilayer pushpin board of claim 1, further including a mounting arrangement for coupling the board to a support surface.

19. The multilayer pushpin board of claim 1, further comprising a frame, at least one of the support substrate or the piercable composite sheet being at least partially disposed in said frame.

20. The multilayer pushpin board of claim 19, wherein the support substrate is removably disposed in said frame.
